(19) United States
(12) Patent Application Publication
(10) Pub. No.: US 2005/0286963 A1
(43) Pub. Date: Dec. 29, 2005

(54) Cleaning tool

(75) Inventor: Darnell B. Exum, Chesapeake, VA (US)

Correspondence Address: JOY L BRYANT, P.C., P O BOX 620, LIGHTFOOT, VA, 23090-0620, US

(73) Assignee: Water Works I, Inc.

(21) Appl. No.: 10/878,844

(22) Filed: Jun. 28, 2004

(51) Int. Cl. A46B 11/00; A47L 7/00; A47L 1/08; B43M 11/02

(52) U.S. Cl. 401/47; 401/46; 401/45; 401/137; 401/138

(57) ABSTRACT

The present invention is directed toward a cleaning tool, kit and method related thereto. The cleaning tool comprises a main housing having an internal passageway. The internal passageway has a first fluid path for communicating a first fluid from a fluid source to a fluid discharge means. The main housing has a first end for attachment to the fluid source. A second end comprises the fluid discharge means and a separate cleaning head. At least one reservoir is in fluid communication with a second fluid path, wherein the first fluid pressurizes the reservoir and mixes with a second fluid to form a solution. A solution discharge means is provided for spraying the solution onto the cleaning head. Control valves are provided for switching between a solution stream and a first fluid stream.

### CROSS-REFERENCE TO DISCLOSURE DOCUMENT

This invention was first disclosed to the U.S. patent and Trademark Office on Jan. 6, 2004 in Disclosure Document No.: 544,894.

### FIELD OF THE INVENTION

The present invention relates to a device and method to support cleaning needs. In particular, the present invention is directed towards a cleaning tool having an end terminating with a fluid discharge means for discharging a first fluid, and a separate cleaning head such that a solution discharge means delivers a solution to the cleaning head.

### BACKGROUND OF THE INVENTION

Cleaning tools which spray water and detergent solutions are useful, for example, for washing automobiles or scrubbing home siding. Presently existing cleaning tools typically attach to a garden hose and employ such features as: cleaning brushes, high pressure sprayers, soap or detergent dispensers, and dilution devices. While all of the above features are necessary for a cleaning tool to be effective, current cleaning tools which combine these features typically waste water; waste cleaning compounds; do not thoroughly mix cleaning compounds with water; and subject the user's hands to water and harsh cleaning compounds.

Water conservation is a major concern. A problem with presently existing cleaning tools is that they waste water. This is a result of the poor design of the water passageways and the way in which the cleaning compounds are dispensed. U.S. Pat. No. 4,899,940 to Leaver describes a cleaning tool typical of those predominant in the art. In the Leaver invention, a washing solution may be discharged in effective amounts from a cavity into a water stream flowing through a wand, by executing a slight rearward displacement of the wand relative to a handle. This causes a wall aperture provided in the wand to be removed from a position between front O-rings to a position communicating with the interior of the cavity. When the wand is thus slightly retracted, the forward flow of water through the wand sets up a slight pressure reduction in the area of the wall aperture, causing the contained washing solution to be drawn into the flowing water stream in controlled quantities. Rinsing off of the washing solution may be accomplished by displacing the wand forwardly again, to position the wall aperture between the O-rings isolated from the washing solution. One problem with this type of system is that the same flowing water stream is used to dispense the washing solution as well as the rinse water. Before soap can be dispensed, extra rinse water remaining in the device's internal passageways must first be displaced by soap solution. Likewise, before rinsing, extra rinse water must be employed to clear the remaining soap solution from the passageways. This results in water being wasted each time the device is switched between dispensing soap solution and dispensing rinse water.

U.S. Pat. No. 6,227,745 to Privett demonstrates the way in which current cleaning tools dispense cleaning compounds. In Privett a small steady stream of soap from a soap container is aspirated into a moving water stream through a metering device. The metering of solutions is necessary when solution concentration is critical, for example, when mixing concentrated insecticides with water. However, soap and water cleaning solutions are effective over a broad range of concentrations, making delicate metering devices unnecessary for this application. Furthermore, metering is wasteful of both water and cleaning compounds. When undiluted soap or cleaning compound enters a moving stream of water, typically, there is inadequate mixing of the undissolved soap or cleaning compound with the water. Thus the generation of suds or foam requires larger amounts of both water and cleaning compounds than would be necessary if the cleaning compounds had been fully mixed.

U.S. Pat. No. 4,614,302 to Rodgers describes an alternative method of introducing detergent into a water spray. Rodgers describes a hose end nozzle assembly in which detergent held in a dispenser can be ejected into an internal mixing chamber and sprayed as a solution. This invention uses more moving parts than other systems making it prone to failure and expensive to manufacture.

One desirable feature of cleaning tools used to spray water and detergent solutions is the addition of a cleaning head or brush to loosen dirt particles embedded in a surface. U.S. Pat. No. 4,066,366 to Reynolds describes one such tool wherein a mop head fits over a tubular frame assembly to aid in the distribution of water and to facilitate the cleaning of the surface of an automobile. While useful for removing dirt, the addition of a brush reduces the efficiency of a tool's high pressure rinsing capabilities. Because water is dispersed through a series of apertures in the mop head, the water cannot be concentrated in a single high velocity spray. U.S. Pat. No. 6,227,745 to Privett attempts to address the problems associated with the addition of a cleaning brush by providing a cleaning tool with a brush that can be quickly removed and other accessories added. Many cleaning tools have adopted a similar means of exchanging spray nozzles and cleaning heads. The problem with such a system is that after applying a cleaning solution through the brush, the user must remove the cleaning head and install a spray nozzle. This exposes the user's hands to water and harsh chemical cleaning compounds and is impractical to use in cold weather.

U.S. Pat. No. 3,989,391 to Thorner attempts to solve some of the above mentioned problems by providing a washing device with a pressure injection soap system. The disclosure teaches a device that performs washing and rinsing operations simultaneously without the need of changing from a brush to a rinse head. However, the Thorner invention is complicated, delicate, and prohibitively expensive to build.

An object of the present invention is to provide a cleaning tool capable of applying a cleaning solution at low pressure and a rinse at high pressure without changing equipment or nozzles.

Another object of the present invention is to provide a cleaning tool that thoroughly mixes and sprays multiple liquids by generating a vortex within a reservoir.

Another object of the present invention is to provide a cleaning tool that employs a reservoir to pre-mix a first fluid and a second fluid prior to dispensing.

Another object of the present invention is to provide a cleaning tool that is inexpensive to manufacture.

Another object of the present invention is to provide a cleaning tool that conserves water and cleaning compounds.

Another object of the present invention is to provide a method for cleaning that employs the cleaning tool of the present invention.

### SUMMARY OF THE INVENTION

The present invention is directed toward a cleaning tool capable of selectively spraying multiple fluids. The tool comprises a main housing having a first end for attachment to a fluid source and a second end having both a cleaning head and a separate fluid discharge means. The fluid discharge means controls the discharge of a first fluid. An internal passageway is disposed within the main housing, and has a first and a second fluid path. The first fluid path communicates a portion of the first fluid from the fluid source to the fluid discharge means. The second fluid path communicates a second portion of the first fluid to a solution discharge means. A solution control valve is positioned in an operable relationship to the second fluid path. In addition a reservoir containing a second fluid is also positioned in an operable relationship to the second fluid path. The operable relationship allows for the second portion of the first fluid and the second fluid to be combined to form a solution.

Another embodiment of the invention is a method for cleaning that employs the tool of the present invention. In practicing the method, a cleaning tool capable of selectively spraying multiple fluids is provided. The cleaning tool is as described above. A first end of the cleaning tool is attached to a fluid source. The reservoir is filled with the second fluid. The solution control valve is operated whereby a second portion of the first fluid is mixed with the second fluid to form the solution which is discharged through the solution discharge means. The surface to be cleaned is scrubbed with the cleaning head. The solution control valve is operated to stop the discharge of the solution. The fluid discharge means is operated to rinse the surface with the first fluid.

### BRIEF DESCRIPTION OF THE DRAWINGS

The accompanying drawings illustrate a complete embodiment of the invention according to the best modes so far devised for the practical application of the principles thereof, and in which:

FIG. 1 depicts the cleaning tool of the present invention with a pressure feed reservoir.

FIG. 2 depicts the cleaning tool of the present invention with a siphon feed reservoir.

FIG. 3 depicts a preferred embodiment of the present invention.

FIG. 3 depicts a preferred embodiment of the reservoir of the present invention.

### DETAILED DESCRIPTION OF THE PREFERRED EMBODIMENTS

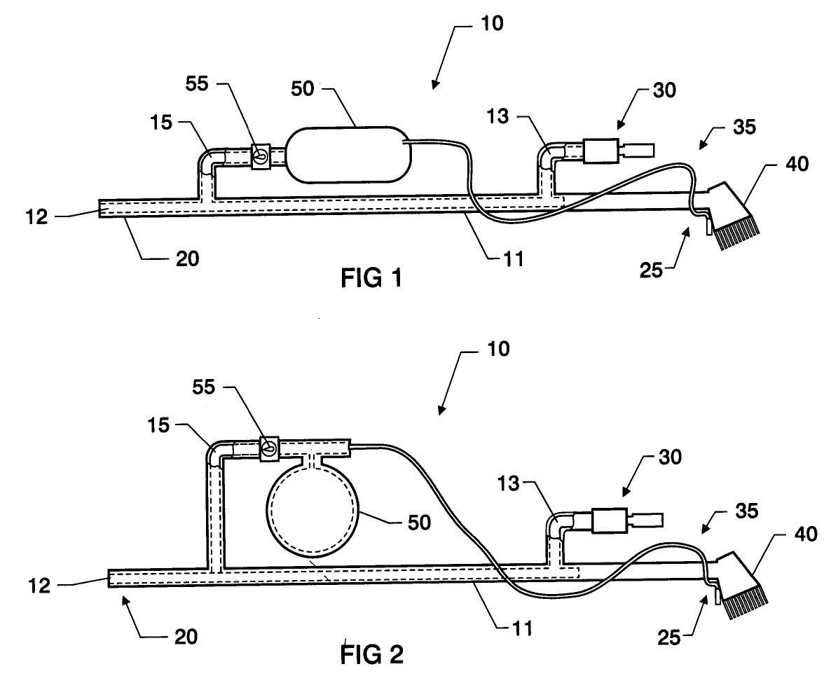

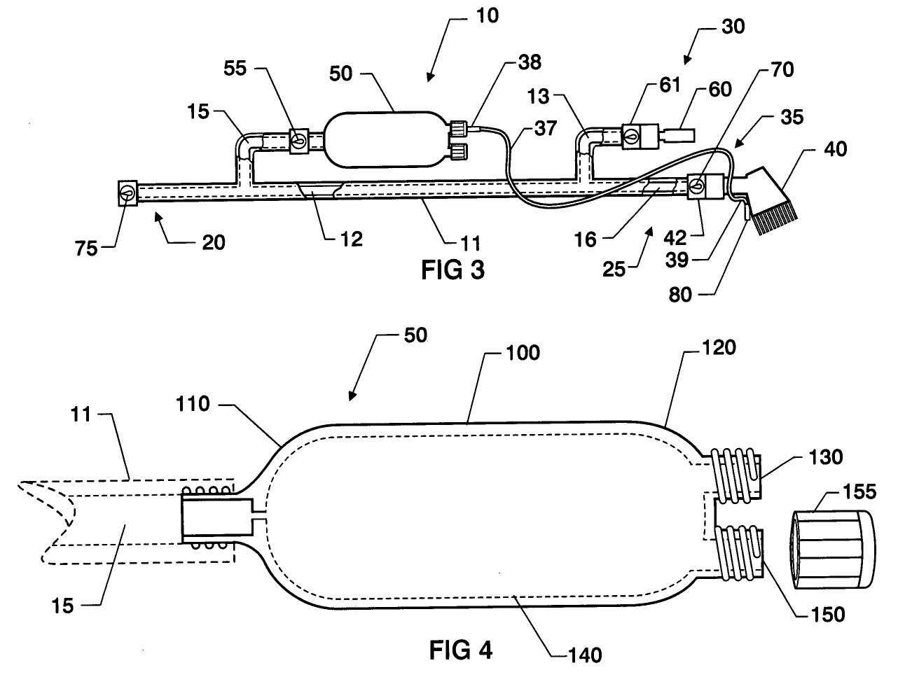

Referring now to the drawings where similar elements are numbered the same, FIGS. 1 and 2 depict the cleaning tool 10 of the present invention. The invention comprises a main housing 11 having a first end 20 for attachment to a fluid source (not shown). A second end 25 of the main housing 11 has both a cleaning head 40, and a separate fluid discharge means 30. The fluid discharge means 30 controls the discharge of a first fluid, and is capable of completely stopping fluid flow as well as discharging fluid. The first fluid may be any fluid known to those of ordinary skill in the art, and is preferably water. The fluid source may be any fluid source, and is typically a low or medium pressure water source such as a garden hose. Alternatively, the fluid source is a pressure washer or other high pressure water source. An internal passageway 12 disposed within the main housing 11 comprises a first fluid path 13 and a second fluid path 15. The first fluid path 13 communicates a first portion of the first fluid from the fluid source to the fluid discharge means 30. The second fluid path 15 communicates a second portion of the first fluid to a solution discharge means 35. The fluid discharge means 30 may be any discharge means known to those of ordinary skill in the art, but is preferably a control valve 61 (FIG. 3). In a most preferred embodiment of the invention as shown in FIG. 3, the fluid discharge means 30 comprises a control valve 61 in combination with a spray nozzle 60. A fixed spray nozzle, an adjustable spray nozzle, or any other spray nozzle known to those of ordinary skill in the art may be used. An example of an adjustable spray nozzle is the type used on a garden hose. Because the cleaning head 40 is separate and distinct form the fluid discharge means 30 a user can switch between a scrubbing mode and a rinsing mode without changing cleaning heads or nozzles, something not achieved with the prior art cleaning tools. This unique feature keeps the user's hands dry and allows the tool to be used during cold weather. In one embodiment of the invention, the cleaning head 40 is a brush, a sponge or a pad. In a preferred embodiment of the invention, the pad is selected from the group consisting of: a woven pad; a scrubbing pad; an absorbent pad; a scouring pad; a nylon pad; and a cotton pad. In an alternative embodiment of the invention, the cleaning head 40 is a brush. FIG. 3 depicts a preferred embodiment of the invention wherein the cleaning head 40 is removable from the main housing 11. An attachment means 42 is affixed to the cleaning head 40 for attachment to the main housing 11. The attachment means 42 may be any attachment means known to those of ordinary skill in the art, such as a threaded union, a male-female attachment means, or a friction fastener. In another embodiment of the invention, the cleaning tool 10 has at least one alternate cleaning head. Alternate cleaning heads may be employed to expand the potential uses of the cleaning tool 10. For instance a soft, non-scratching brush or a chamois cleaning head is used for cleaning automobiles while more abrasive cleaning heads are used for cleaning tougher surfaces, such as home siding.

In a preferred embodiment of the cleaning tool 10 as shown in FIG. 3, the first end 20 of the main housing 11 further comprises a main valve 75 in an operable relationship to both the first fluid path 13 and second fluid path 15. The main valve 75 provides a means of completely stopping the flow of all fluid through the cleaning tool 10. The main valve may be any valve known to those of ordinary skill in the art, such as a shutoff valve, a gate valve, a ball valve, or a threaded valve. In another embodiment of the present invention, the internal passageway 12 has a third fluid path 16 to communicate a third portion of the first fluid to the cleaning head 40. A control valve 70 disposed within the third fluid path controls the flow of the first fluid through the third fluid path 16. The control valve 70 is capable of completely stopping fluid flow as well as controlling the rate of fluid flow through the third fluid path 16. The control valve 70 is any control valve known to those of ordinary skill in the art, such as a shutoff valve, a gate valve, a ball valve, or a threaded valve. The third fluid path 16 provides a mechanism for rinsing the cleaning head 10 with the first fluid without requiring removal of the cleaning solution from the internal passageways. This water saving feature was non-existent prior to this invention.

Referring to FIGS. 1, 2, and 3, a reservoir 50 holds a second fluid which may be any fluid known to those of ordinary skill in the art, such as an insecticide, a soap, a detergent, or a concentrated cleaning compound. Preferably the second fluid is a concentrated cleaning compound. When the cleaning tool 10 is used for washing cars, a concentrated car washing soap or detergent is contained within the reservoir. In a preferred embodiment of the invention, as shown in FIG. 4, an opening 150 disposed within the reservoir 50 provides a means for filling the reservoir with the second fluid. Once filled, the opening 150 is sealed with a removable cap 155. Referring back to FIGS. 1, 2, and 3, the reservoir 50 is positioned in an operable relationship to the second fluid path 15. The operable relationship allows for the second portion of the first fluid and the second fluid to be combined to form a solution. The solution discharge means 35 delivers the solution to the cleaning head 40. A solution control valve 55 disposed within the second fluid path 15 controls the flow of solution to the cleaning head 40 and may be any control valve known to those of ordinary skill in the art, such as a shutoff valve, a gate valve, a ball valve, or a threaded valve. In a preferred embodiment of the invention, the solution control valve 55 is positioned proximate to an end of the reservoir 50.

The reservoir 50 is preferably either a siphon feed reservoir, as shown in FIG. 2; a pressure feed reservoir, as shown in FIG. 1; or any other type of reservoir known to those of ordinary skill in the art. A siphon feed reservoir is used when precise metering of solution concentration is desired. For purposes of washing automobiles with typical cleaning compounds, a pressure feed reservoir is most preferred. FIG. 4 depicts a preferred embodiment of the present invention, wherein the reservoir 50 is a pressure fed reservoir bottle 100. A first end 110 of the reservoir bottle 100 is fixedly attached to the main housing 11. In one embodiment of the invention, the reservoir bottle 100 is removable from the main housing. A second end 120 of the reservoir bottle 100 has a discharge opening 130 disposed therein. The reservoir bottle 100 is in fluid communication with the second fluid path 15. In a preferred embodiment of the invention, the reservoir bottle 100 is essentially spherical, wherein the first fluid impacts an interior wall 140 of the reservoir bottle 100 at an angle capable of generating a vortex. The vortex completely mixes the first fluid with the second fluid. This complete mixing of fluid components in a cleaning tool was not available before this invention.

In a preferred embodiment of the invention, as shown in FIG. 3, the solution discharge means 35 comprises at least one discharge tube 37. The discharge tube 37 has a first end 38 fixedly attached to a discharge opening 130 (FIG. 4) disposed in the reservoir 50. Referring back to FIG. 3, a second end 39 of the discharge tube terminates proximate to the cleaning head 40. In a preferred embodiment of the invention, the second end 39 of the discharge tube 37 is fixedly attached to the cleaning head 40. In another embodiment of the invention, the second end 39 of the discharge tube 37 comprises a spray jet nozzle 80. The size and type of spray jets vary depending on the type of fluids to be sprayed and the application desired.

In a most preferred embodiment of the invention, as shown in FIG. 3, the first end 20 of the main housing 11 comprises a main valve 75 and an attachment means 72 for attachment to a fluid source. The attachment means may be any attachment means known to those of ordinary skill in the art, such as a threaded valve. The second end 25 of the main housing 11 has a removable cleaning head 40 and a separate fluid discharge means 30. The removable cleaning head 40 has an attachment means 42 for attachment to the main housing 11. The fluid discharge means 30 comprises a spray nozzle 80 in combination with a control valve 70. An internal passageway 12 within the main housing 11 has three fluid paths: a first fluid path 13 for communicating a first portion of a first fluid from the fluid source to the fluid discharge means 30; a second fluid path 15 for communicating a second portion of the first fluid to a removable reservoir 50; and a third fluid path 16 for communicating a third portion of the first fluid to the removable cleaning head 40. The third fluid path 16 has a control valve 70 disposed therein. A solution control valve 55 is disposed within the second fluid path 15 proximate to the removable reservoir 50.

As shown in FIG. 4, the removable reservoir 50 comprises a reservoir bottle 100. The reservoir bottle 100 has a first end 110 fixedly attached to the main housing 11. The interior of the reservoir bottle 100 is in fluid communication with the second fluid path 15. A second end 120 of the reservoir bottle 100 has a discharge opening 130 disposed therein. An opening 150 disposed within the reservoir bottle 100 is sealed with a removable cap 155. The reservoir bottle 100 is positioned whereby the second portion of the first fluid flows through the solution control valve (not pictured) and enters the first end 110 of the reservoir bottle 100. Inside the reservoir bottle, the second portion of the first fluid impacts an interior wall 140 of the reservoir bottle 100, generates a vortex, and mixes with a second fluid to form a solution.

Referring back to FIG. 3, a discharge tube 37 has a first end 38 fixedly attached to the discharge opening (not shown) of the reservoir 50. A second end 39 of the discharge tube 37 comprises at least one spray jet nozzle 80. The spray jet nozzle 80 is removably attached to the removable cleaning head 40. The discharge tube 37 communicates the solution from the reservoir 50 to the removable cleaning head 40.

In practicing the method of the present invention, the cleaning tool 10 is provided and attached to a first fluid source. The first fluid source is preferably a water source, such as a garden hose. A cleaning head 40 is attached to the cleaning tool. A soft, non-scratching brush or a chamois cleaning head is used for cleaning automobiles. More abrasive cleaning heads are used for cleaning tougher surfaces such as house siding, driveways, industrial equipment, and other sturdy surfaces. The reservoir 50 is filled with the second fluid, which is preferably a concentrated cleaning compound. The main valve 75 and solution control valve 55 are opened, thereby introducing the first fluid into the reservoir 50. A vortex action within the reservoir thoroughly mixes the first and second fluids together into a solution that discharges through the solution discharge means and onto the cleaning head 40. The solution is rinsed from the surface to be cleaned by closing the solution control valve 55, and opening the fluid discharge means 30 to discharge the first fluid. The aforementioned steps may be performed in any sequence to give the desired result. For example, the surface may be rinsed with the first fluid prior to scrubbing the surface with the cleaning head.

The above description and drawings are only illustrative of preferred embodiments which achieve the objects, features and advantages of the present invention, and it is not intended that the present invention be limited thereto. Any modification of the present invention which comes within the spirit and scope of the following claims is considered part of the present invention.

1. A cleaning tool capable of selectively spraying multiple fluids, the tool comprising:
a main housing having a first end for attachment to a fluid source and a second end having both a cleaning head and a separate fluid discharge means for controlling the discharge of a first fluid; the main housing further comprising an internal passageway disposed within the main housing having a first fluid path for communicating a first portion of the first fluid from the fluid source to the fluid discharge means a second fluid path for communicating a second portion of the first fluid to a solution discharge means and a solution control valve positioned in an operable relationship to the second fluid path; and
a reservoir, containing a second fluid, positioned in an operable relationship to the second fluid path wherein the second portion of the first fluid and the second fluid are combined to form a solution.

2. A cleaning tool according to claim 1, wherein the fluid discharge means comprises a control valve.

3. A cleaning tool according to claim 2, wherein the fluid discharge means further comprises a spray nozzle.

4. A cleaning tool according to claim 1, wherein the cleaning head is either a brush; a sponge; or a pad.

5. A cleaning tool according to claim 4, wherein the pad is selected from the group consisting of: a woven pad; a scrubbing pad; an absorbent pad; a scouring pad; a nylon pad; and a cotton pad.

6. A cleaning tool according to claim 4, wherein the cleaning head is a brush.

7. A cleaning tool according to claim 1, wherein the first fluid is water.

8. A cleaning tool according to claim 1, wherein the second fluid is a concentrated cleaning compound.

9. A cleaning tool according to claim 1, wherein the internal passageway further comprises a third fluid path communicating a third portion of the first fluid to the cleaning head and wherein a control valve disposed within the third fluid path controls the flow of the third portion of the first fluid through the third fluid path.

10. A cleaning tool according to claim 1, wherein the first end of the main housing further comprises a main valve, in an operable relationship to the first and second fluid paths.

11. A cleaning tool according to claim 1, wherein the cleaning head is a removable cleaning head.

12. A cleaning tool according to claim 11, wherein the removable cleaning head has an attachment means affixed thereto for attachment to the main housing.

13. A cleaning tool according to claim 1, wherein the reservoir comprises a reservoir bottle.

14. A cleaning tool according to claim 13, wherein the reservoir bottle has a first end fixedly attached to the main housing in fluid communication with the second fluid path and a second end having a discharge opening disposed therein.

15. A cleaning tool according to claim 13, wherein the reservoir bottle is essentially spherical whereby the first fluid impacts an interior wall of the reservoir bottle generating a vortex therein.

16. A cleaning tool according to claim 13, wherein an opening is disposed within the reservoir bottle and wherein the opening is sealed with a removable cap.

17. A cleaning tool according to claim 13, wherein the reservoir bottle is removable.

18. A cleaning tool according to claim 1, wherein the solution discharge means comprises at least one discharge tube having a first end fixedly attached to a discharge opening disposed in the reservoir and a second end terminating proximate to the cleaning head.

19. A cleaning tool according to claim 18, wherein the second end of the discharge tube is fixedly attached to the cleaning head.

20. A cleaning tool according to claim 18, wherein the second end of the discharge tube comprises a spray jet nozzle.

21. A cleaning tool according to claim 1, wherein the solution control valve is proximate to an end of the reservoir.

22. A cleaning tool according to claim 1, further comprising at least one alternate cleaning head.

23. A cleaning tool capable of selectively spraying multiple fluids, the tool comprising:
A main housing having a first end and a second end, the first end of the main housing comprising a main valve and an attachment means for attachment to a fluid source; the second end of the main housing having both a removable brush having an attachment means for attachment to the main housing and a separate adjustable spray nozzle in combination with a control valve;
the main housing further having an internal passageway, the internal passageway having a first fluid path for communicating a first portion of a first fluid from the fluid source to the fluid discharge means, a second fluid path for communicating a second portion of the first fluid to a removable reservoir, a third fluid path having a control valve disposed therein for communicating a third portion of the first fluid to the cleaning head, and wherein a solution control valve is disposed within the second fluid path proximate to the removable reservoir;
wherein the removable reservoir comprises a reservoir bottle having a first end fixedly attached to the main housing in fluid communication with the second fluid path and a second end having a discharge opening disposed therein, and an opening-disposed within the reservoir bottle wherein the opening is sealed with a removable cap; and wherein the reservoir bottle is positioned whereby the fluid from the second fluid path flows through the solution control valve, enters the first end of the reservoir bottle, impacts an interior wall of the reservoir bottle, generates a vortex and mixes with a second fluid to form a solution; and
a discharge tube having a first end fixedly attached to the reservoir bottle at the discharge opening and a second end comprising at least one spray jet nozzle removably attached to the removable brush whereby the discharge tube communicates the solution from the reservoir bottle to the removable brush.

24. A method for cleaning comprising the steps of:
a) providing a cleaning tool capable of selectively spraying multiple fluids, the tool comprising a main housing having a first end for attachment to a fluid source and a second end having both a cleaning head and a separate fluid discharge means for controlling the discharge of a first fluid; the main housing further comprising an internal passageway disposed within the main housing comprising a first fluid path for communicating a first portion of the first fluid from the fluid source to the fluid discharge means, a second fluid path for communicating a second portion of the first fluid to a solution discharge means and wherein a solution control valve is positioned in an operable relationship to the second fluid path; and
a reservoir, containing a second fluid, positioned in an operable relationship to the second fluid path wherein the second portion of the first fluid and the second fluid are combined to form a solution;
b) attaching the first end of the main housing to the fluid source;
c) filling the reservoir with the second fluid;
d) operating the solution control valve whereby the second portion of the first fluid is mixed with the second fluid to form the solution; and whereby the solution is discharged through the solution discharge means;
e) scrubbing a surface with the cleaning head;
f) operating the solution control valve to stop the discharge of the solution; and
g) operating the fluid discharge means to rinse the surface with the first fluid.

25. A method for cleaning according to claim 24, wherein the first fluid is water.

26. A method according to claim 24, wherein the second fluid is a concentrated cleaning compound.

27. A method according to claim 24, wherein the cleaning tool further comprises a main valve disposed within the first end of the main housing in an operable relationship to the first and second fluid paths.

28. A method according to claim 27, further comprising the step of controlling the flow of the first fluid by operating the main valve.

29. A method according to claim 24, wherein the internal passageway of the main housing further comprises a third fluid path communicating a third portion of the first fluid to the cleaning head and wherein a control valve disposed within the third fluid path controls the flow of the third portion of the first fluid through the third fluid path.

30. A method according to claim 29, further comprising the step of rinsing the cleaning head with the first fluid by operating the control valve disposed within the third fluid path.

31. A method according to claim 24, wherein the fluid discharge means comprises a control valve in combination with an adjustable spray nozzle.

32. A method according to claim 31, further comprising the steps of:
a) opening the control valve of the fluid discharge means to discharge the first fluid;
b) adjusting the adjustable spray nozzle to discharge the first fluid in a spray pattern; and
c) closing the control valve of the fluid discharge means.

33. A method according to claim 24, wherein the reservoir comprises a removable reservoir bottle having a first end fixedly attached to the main housing in fluid communication with the second fluid path and a second end having a discharge opening disposed therein; and whereby the solution control valve is proximate to the first end of the reservoir bottle; and
wherein the solution discharge means comprises a discharge tube having a first end fixedly attached to a discharge opening disposed in the reservoir, and a second end comprising at least one spray jet nozzle removably attached to the cleaning head.

34. A method according to claim 33, further comprising the steps of:
a) introducing the first fluid into the reservoir bottle, wherein the first fluid enters the first end of the reservoir bottle, impacts an interior wall of the reservoir bottle, generates a vortex within the reservoir bottle and mixes with the second fluid to form a solution; and
b) discharging the solution though the solution discharge means.

35. A method according to claim 24, wherein an opening is disposed within the reservoir and wherein the opening is sealed with a removable cap, and further comprising the steps of:
a) removing the removable cap from the reservoir;
b) filling the reservoir with the second fluid; and
c) replacing the removable cap on the reservoir.

36. A method according to claim 24, wherein the cleaning head is a removable cleaning head comprising an attachment means for attaching the cleaning head to the second end of the main housing, and wherein the cleaning tool further comprises at least one alternate cleaning head.

37. A method according to claim 36, further comprising the steps of:
a) removing the cleaning head from the main housing; and
b) attaching the alternate cleaning head to the main housing.
